(19) United States
(12) Patent Application Publication
(10) Pub. No.: US 2023/0361637 A1
(43) Pub. Date: Nov. 9, 2023

(54) ELECTRIC MACHINES WITH ENHANCED ELECTROMAGNETIC INTERACTION

(71) Applicant: NATIONAL RESEARCH COUNCIL OF CANADA, Ottawa (CA)

(72) Inventors: Maged IBRAHIM, Cairo (EG); Fabrice BERNIER, Montreal (CA); Jean-Michel LAMARRE, Boucherville (CA)

(73) Assignee: NATIONAL RESEARCH COUNCIL OF CANADA, Ottawa, ON (CA)

(21) Appl. No.: 18/042,880

(22) PCT Filed: Sep. 16, 2021
(86) PCT No.: PCT/CA2021/051297

§ 371 Date: Feb. 24, 2023

Related U.S. Application Data
(60) Provisional application No. 63/079,259, filed on Sep. 16, 2020.

(51) Int. Cl. H02K 1/2786; H02K 1/20; H02K 1/16

(52) U.S. Cl. CPC H02K 1/2786; H02K 1/16; H02K 1/20; H02K 2201/12

(57) ABSTRACT

An electrical machine, which may be a motor and/or a generator has a rotor mounted to rotate about an axis. A plurality of magnetic poles are spaced circumferentially around the rotor in the bore. The rotor comprises a shell shaped to provide a toroidal bore centered on the axis. A slit extends circumferentially around the rotor. The slit penetrates through the shell into the bore. The electrical machine also includes a stator that is supported in the bore by one or more supports extending through the slit of the rotor. The stator carries plural windings that are spaced apart around the bore.

### CROSS-REFERENCE TO RELATED APPLICATION

This application claims priority from U.S. Application No. 63/079259 filed 16 Sep. 2020 and entitled ELECTRIC MACHINES WITH ENHANCED ELECTROMAGNETIC INTERACTION which is hereby incorporated herein by reference for all purposes. For purposes of the United States of America, this application claims the benefit under 35 U.S.C. §119 of U.S. Application No. 63/079259 filed 16 Sep. 2020 and entitled ELECTRIC MACHINES WITH ENHANCEDELECTROMAGNETIC INTERACTION.

### FIELD

This invention relates to electric machines such as electric motors and electric generators. Some embodiments provide permanent magnet motors and/or generators.

### BACKGROUND

Electric motors convert electrical power into rotary motion. Electric generators convert rotary motion into electrical power. The term “electric machine” encompasses both electric motors and electric generators.

There is a need for electric machines that are more energy efficient. There is also a need for electric machines that have high power to weight ratios. For example, both of these needs exist in the field of electrically powered aviation (e.g. drones or airplanes) and electric vehicles.

A typical electric motor has a generally cylindrical rotor mounted to rotate inside a cylindrical stator. The radially outer surface of the rotor is separated from radially innermost parts of the stator by an air gap that provides mechanical clearance. The rotor is caused to rotate by the interaction of magnetic fields generated by electromagnets in the stator with magnetic fields associated with magnets in the rotor.

Some electric motors have an axial flux geometry in which magnetic fields of magnets on a face of a rotor interact with coils of a stator located in front of the rotor. Some axial flux electric motors have two rotors, with one rotor on each side of the stator.

In some electric motors (e.g. induction motors) the rotor includes coils and the magnetic fields of the rotor are generated by electrical currents in the coils. In permanent magnet motors the magnetic fields of the rotor are generated by permanent magnets carried by the rotor. Permanent magnet motors are typically more electrically efficient than induction motors.

In a permanent magnet motor the rotor may carry permanent magnets circumferentially spaced apart around the rotor. The stator may carry electromagnets circumferentially spaced apart around the stator. The electromagnets of the stator can be energized to create magnetic fields which interact with magnetic fields of the magnets on the rotor. The magnetic fields can be caused to act in a way that applies torque to the rotor (and thereby makes the rotor turn) by energizing the electromagnets of the stator in an appropriate sequence or pattern.

Heat generation in electric machines is a problem. Heating can arise from material losses such as joule heating, hysteresis and eddy current losses. This heat, if not removed can cause temperature rise which can increase the rate that energy is lost. Furthermore an increase in operating temperature of an electric machine is detrimental to the long term reliability of the machine. Higher operating temperatures can also force designers to use higher grade, more expensive magnets that are capable of retaining their magnetic properties despite higher operating temperatures. To reduce heating effects, current densities in coils of conventional motors are typically designed to be < 10 A/mm². Higher current densities in conventional electric motors may cause the coil temperature to rise sufficiently to damage electrical insulation and/or demagnetize permanent magnets.

There is a general need for electric machines that provide one or more of: improved electrical efficiency, higher power to weight ratio, integrated cooling and reduced cost of manufacture. There is also a need for new alternatives to existing geometries for electric machines.

### SUMMARY

This invention relates to electrical machines including motors and generators. The invention has various aspects. These include, without limitation:
Electric machines that have a geometry in which a rotor includes a toroidal bore and a stator located in the toroidal bore. The stator is supported by supports that extend through a slit in the rotor. This geometry can advantageously be applied to provide a large area for electromagnetic interaction between the rotor and stator in a relatively small package.
Electric machines as above in which the rotor carries permanent magnets that are oriented tangentially relative to the bore in the rotor and are separated by ferromagnetic material which provides magnetic poles. The ferromagnetic material can advantageously be a material that can be formed, for example by compaction or an additive machining process. The ferromagnetic material may, for example, comprise a soft magnetic composite. Forming the ferromagnetic material to have a 3D geometry as described herein can optimize 3D flux paths to achieve compact and more efficient motors. Additive manufacturing processes can be used to efficiently fabricate complex 3D structures. This construction advantageously provides opportunities to shape the rotor in a way that improves utilization of the ferromagnetic material and/or efficiency of the electric machine.
Electric machines as any of the above in which the stator is actively cooled. For example, the stator may comprise channels that are supplied with a coolant by way of the slit. This construction can advantageously improve efficiency and/or reliability by controlling temperature of the stator. This construction can also help to control temperature of the rotor by transfer of heat from the rotor to the stator.
Electric machines as any of the above comprising a cooled surface outwardly adjacent to the rotor. Such a cooled surface can remove heat from the rotor, thereby controlling a temperature of the rotor.
Parts for electric machines (e.g. rotors and stators).
Methods for constructing electric machines.
Any of the above where the roles of the rotor and stator are reversed.
These aspects may be applied in any combinations or individually. The following are more specific example aspects of this invention.

One aspect of the invention provides electric machines which comprise a rotor mounted to rotate about an axis. The rotor comprises a shell shaped to provide a toroidal bore centered on the axis and has a slit extending circumferentially around the rotor. The slit penetrates through the shell into the bore. The rotor comprises a plurality of magnetic poles spaced circumferentially around the rotor in the bore. A stator is supported in the bore by support(s) extending through the slit of the rotor. The stator carries a plurality of windings spaced apart around the bore.

In some embodiments, the magnetic poles each extend in a poloidal direction around an interior surface of the bore from a location near a first edge of the slit to a location near a second edge of the slit. In some embodiments, the slit has a width that is less than one third of the circumference in the poloidal direction of an inner surface of the rotor. In some embodiments, the slit spans an angle relative to a centroid of a cross-section of the bore in a plane that includes the axis and the angle is less than or equal to sixty degrees. In some embodiments, the ratio between an area of the slit to an area of the toroidal surface on which the inner surface of the rotor lies is not more than 1:12.

In some embodiments, the rotor comprises a plurality of spaced apart ring magnets that extend around the rotor in the poloidal direction. The ring magnets may have gaps aligned with the slit. In some embodiments, each of the ring magnets is magnetized in a direction that is tangential relative to the rotor and adjacent ring magnets are separated by a section of a ferromagnetic material that provides one of the poles. In some embodiments, the surface of the ferromagnetic material on an outside of the rotor is formed with a cut out or groove that extends in the poloidal direction. The ferromagnetic material may comprise a soft magnetic composite (SMC). In some embodiments, the ring magnets form one or more Halbach arrays. In some embodiments, the ring magnets are magnetized in a radial direction and the shell comprises a continuous layer of a ferromagnetic material backing the magnets on sides of the magnets away from the bore.

In some embodiments, the stator comprises cooling channels containing a cooling fluid. The electric machine comprises conduits that extend through the slit. The conduits are connected to supply the cooling fluid to the cooling channels and/or to remove the cooling fluid from the cooling channels. In some embodiments, the cooling channels extend toroidally around the stator. In some embodiments, the cooling channels extend around a centerline of the stator.

In some embodiments, the stator comprises a core of a ferromagnetic material and the windings comprise toroidal windings wound around the core at locations spaced apart along the core. The toroidal windings may comprise integral or fractional windings. In some embodiments, the core comprises ribs of the ferromagnetic material located between adjacent windings. The ribs extend around the core in the poloidal direction. In some embodiments, the ribs are interrupted at the location where the ribs cross the slit. In some embodiments, the ribs are interrupted by V-shaped cutouts that are aligned with the slit. In some embodiments, the outer surfaces of the toroidal windings and outer surfaces of the ribs are aligned with one another. In some embodiments, the outer surfaces of the toroidal windings are recessed toward the stator core relative to outer surfaces of the ribs.

In some embodiments, the electric machine comprises a casing shaped to conform with an outer surface of the rotor. The casing is arranged to provide a clearance gap between the casing and the rotor. In some embodiments, the casing has cooling channels located adjacent to the rotor and containing a cooling fluid.

In some embodiments, the supports comprise electrical conductors connected to carry electrical power to or from the stator. In some embodiments, the stator comprises spokes located between the windings and extending radially away from the stator.

In some embodiments, the slit is located on a side of the rotor facing away from the axis. In some embodiments, the slit is located on a side of the rotor facing toward the axis.

In some embodiments, the bore in a plane that includes the axis has a circular cross section. In some embodiments the bore in a plane that includes the axis has an elliptical cross section.

Further aspects and example embodiments are illustrated in the accompanying drawings and/or described in the following description.

It is emphasized that the invention relates to all combinations of the above features, even if these are recited in different claims.

### BRIEF DESCRIPTION OF THE DRAWINGS

The accompanying drawings illustrate non-limiting example embodiments of the invention.

FIGS. 1 and 1A are schematic diagrams of a cross section of a permanent magnet motor according to example embodiments. FIG. 1B is a perspective view of a section of the FIG. 1A motor.

FIG. 2 is a perspective view of a section of a stator core of the FIG. 1A motor according to an example embodiment. FIG. 2A is a perspective view of a section of a wound stator of the FIG. 1A motor according to an example embodiment. FIG. 2B is a perspective view of a section of a wound stator received within a bore of a rotor. FIG. 2C is a perspective view of a section of a wound stator without ribs.

FIG. 3 is a perspective view of a section of a rotor according to an example embodiment. FIG. 3A shows the direction of magnetism of various components of the FIG. 3 rotor. FIGS. 3B and 3C are illustrations which respectively show a magnet that is divided into segments in a poloidal direction and a magnet which is segmented in a radial direction.

FIG. 4 is a perspective view of a section of a rotor according to an example embodiment. FIG. 4A shows the direction of magnetism of various components of the FIG. 4 rotor.

FIG. 5 is a perspective view of a section of a rotor according to an example embodiment. FIGS. 5A-5D are two-dimensional cross sectional views of various embodiments of a cutout section of the FIG. 5 rotor.

FIG. 6 is a perspective view of a section of a Halbach array rotor according to an example embodiment. FIG. 6A shows the direction of magnetism of various components of an example embodiment of the FIG. 6 rotor.

FIG. 7 is a perspective view of a section of a magnetic motor assembly according to an example embodiment. FIGS. 7A-7F are perspective views of sections of various components of the FIG. 7 magnetic motor assembly.

FIGS. 8A-8F depict results of simulations that predict performance of electric machines as described herein.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

The inventors have recognized that the geometries of conventional electric motors in which electromagnetic interactions between a rotor and stator occur in a cylindrical shell and the geometries of axial flux motors in which electromagnetic interactions between rotor and stator occur in a disk shaped space within an axial air gap are obstacles to improving efficiency.

This disclosure describes electric machines having geometries in which interactions of magnetic fields between a rotor and stator occur in a toroidal shell. This geometry can advantageously provide an increased area of electromagnetic interaction between the stator and rotor in an electric machine that fits within a given volume.

Electric machines as described herein can include a stator which comprises soft magnetic composite materials (“SMCs”). The SMCs may be shaped to make efficient use of material and may include tangentially oriented magnetized magnets. These structures which are described in detail herein can provide significant manufacturing and performance advantages.

Another feature of the disclosed electric machines is a cooling arrangement that can provide very efficient heat extraction. The disclosed cooling arrangements can facilitate high current densities in electromagnet windings (e.g. current densities of 10 A/mm² or more) without utilizing expensive / exotic materials. The effective cooling, can allow an electric machine to operate at relatively high power while keeping the temperature of magnetic coils and other components relatively low. Keeping a relatively low operating temperature can lead to improved efficiency (e.g. keeping temperature of magnetic coils below a threshold at which electrical resistance of the coils increases significantly can reduce I²R losses and keeping temperatures of magnetic materials low can reduce material losses such as joule heating, hysteresis and eddy current losses). Keeping temperatures of the components of a magnetic machine relatively low can also improve reliability (e.g. by avoiding high temperatures that would degrade electrical insulation or other components).

### 1. Overall Architecture

Electric machines as described herein include a rotor and stator arranged to provide a toroidal surface over which electromagnetic interaction between the rotor and stator can occur. In preferred embodiments the stator is located within a toroidal chamber in the rotor. The stator may be supported by members that extend through a slit in the rotor.

“toroidal surface” means a surface of revolution with a hole in the middle. A toroidal surface can be generated, for example, by sweeping a planar shape around an axis of revolution that is in a plane of the shape and is spaced apart from the boundary of the shape. The shape may, for example, be a circle, ellipse, rectangle, square etc. The surface of a donut shape is an example of a toroidal surface.

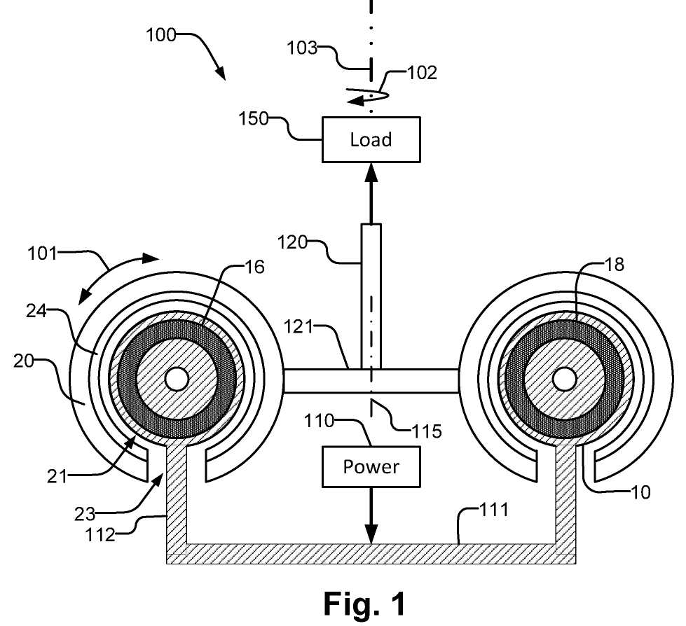

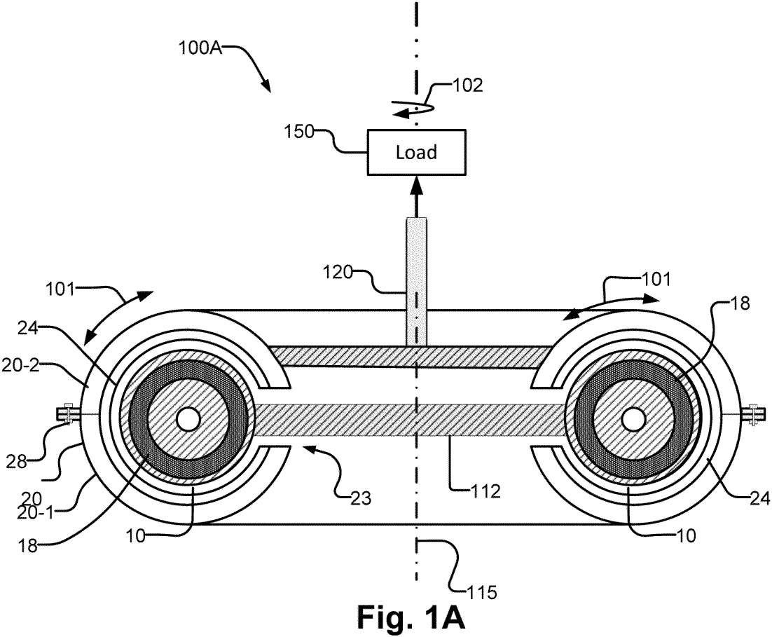

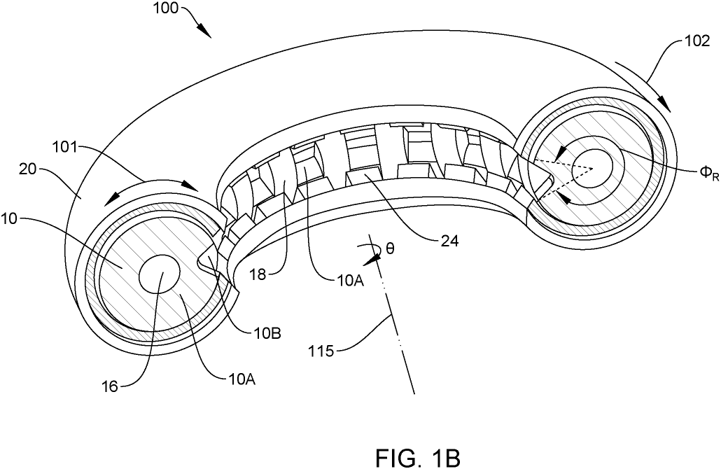

A toroid or toroidal surface has a toroidal direction that follows a circle centered on the axis of revolution in a plane perpendicular to the axis of revolution. A toroid or toroidal surface also has a poloidal direction that extends around the shape in a plane that includes the axis of revolution. The toroidal and poloidal directions are indicated in FIG. 1B by arrows 102 and 101 respectively.

The following discussion describes constructions for example machines. Such constructions may also be applied to motors and generators.

FIG. 1 is a schematic cross section view of a permanent magnet machine 100 according to an example embodiment. Machine 100 may be operated as a motor or as a generator. In this example machine 100 includes a shaft 120 that is driven to rotate a mechanical load 150 when machine 100 is connected to electrical power source 110. Machine 100 may be made to generate electrical power by driving shaft 120 to rotate.

Machine 100 comprises a stator 10 received within a toroidal bore 21 in a rotor 20. In this example, stator 10 is shaped generally like a circular torus and/or elliptic torus although other toroidal shapes are possible. Rotor 20 is supported to rotate about an axis 115 by suitable bearings (not shown in FIG. 1). Rotor 20 wraps around stator 10 in a poloidal direction 101 to provide a relatively large area of interaction between rotor 20 and stator 10.

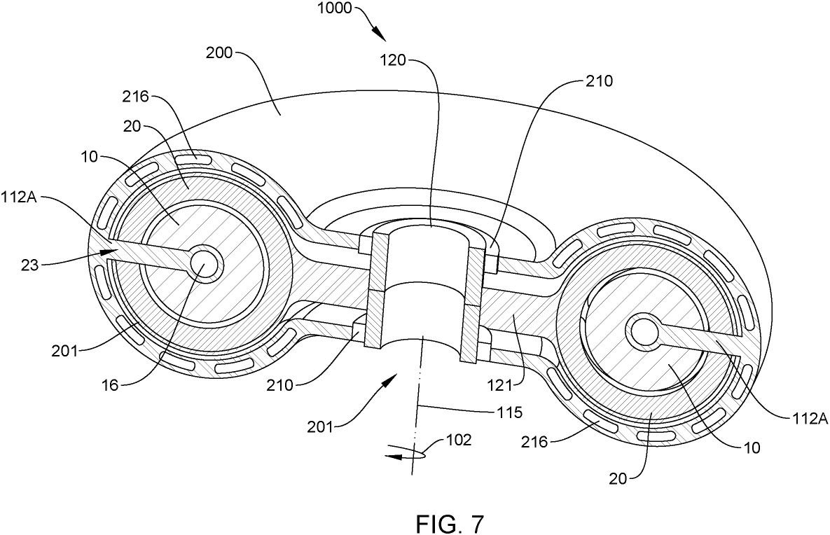

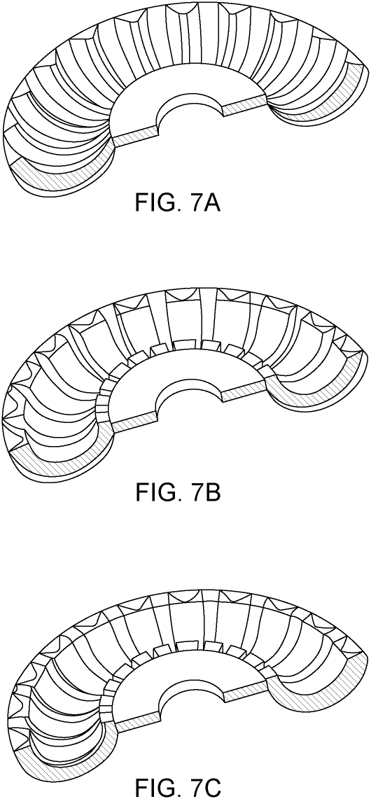

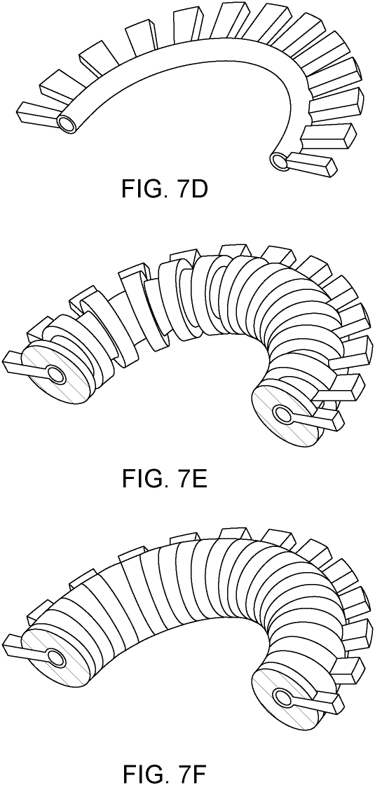

Stator 10 is supported by one or more supports 112 that extend through a slit 23. Slit 23 extends around rotor 20 in a toroidal direction. Support(s) 112 are connected to a base 111 which may be a casing (e.g. casing 200 in FIG. 7).

Electrical power may be delivered to or from stator 10 by way of electrical conductors (not shown) that pass through slit 23. The electrical conductors may, for example, be inside or attached to one or more supports 112.

The geometry illustrated in FIG. 1 may be varied. For example, the location of slit 23 in the poloidal direction may be altered. FIG. 1A illustrates a motor 100A according to another example embodiment wherein slit 23 faces toward axis 115. The embodiment of FIG. 1A has the advantage that the length of slit 23 (and therefore the total area of slit 23) is reduced as compared to the length and total area of slit 23 in the embodiment of FIG. 1.

Slit 23 may be relatively narrow, thus providing a large area for magnetic interaction between stator 10 and rotor 20. Slit 23 does not need to be any wider than necessary to accommodate support(s) 112 plus necessary mechanical clearance between support(s) 112 and the edges of slit 23. The relative width of slit 23 may be indicated in various ways. For example:
slit 23 may have a width that is less than one half of the circumference in the poloidal direction of the inner surface of rotor 20. Preferably the width of slit 23 is not more than one third or not more than one quarter or not more than one sixth or not more than one twelfth of the circumference in the poloidal direction of the inner surface of rotor 20. In some embodiments a width of slit 23 is in the range of about 10% to 20% of a distance extending in a poloidal direction along the inner surface of bore 21 around bore 21 from one edge of slit 23 to an opposing edge of slit 23.
slit 23 may span an angle relative to a center or centroid of the cross-sectional shape that defines an inner toroidal surface of rotor 20 that is less than 180 degrees. Preferably the angle is not more than 120 degrees or not more than 90 degrees or not more than sixty degrees or not more than 30 degrees. For example rotor 20 may span a poloidal angular range Φ_{R} (see FIG. 1B) in a range of 180° -355° about the toroidal central axis of stator 10. In the FIG. 1B example embodiment, rotor 20 spans a poloidal angle Φ_{R} of about 300°.
a ratio of the area of slit 23 to the area of a toroidal surface on which the inner surface of rotor 20 lies is less than 1:2 and is preferably not more than 1:3 or not more than 1:4 or not more than 1:6 or not more than 1:12.
slit 23 may have a width that is less than a maximum diameter of rotor 10. For example, a ratio of the width of slit 23 to a maximum diameter of rotor 10 may be less than 2:3 and is preferably not more than 1:2 or 1:4 or 1:6.

A clearance between an outer surface of stator 10 and an inner surface of rotor 20 which faces into toroidal bore 21 may be made small. This increases the strength of magnetic interactions between magnetic fields arising from stator 10 and magnetic fields arising from rotor 20.

There are various ways to make a machine as described herein in which stator 10 is located inside toroidal bore 21 of rotor 20 and rotor 20 wraps a majority of the way around stator 10. These include:
making rotor 20 in two or more parts that can be assembled around stator 10. For example, FIG. 1A shows a rotor 20 made from parts 20-1 and 20-2 that may be assembled around rotor and then joined by fasteners 27.
molding or otherwise forming rotor 20 around stator 10.
making stator 10 in parts that can be introduced into rotor 20 through slit 23 or another aperture in rotor 20 and assembled inside rotor 20.
making stator 10 and/or rotor 20 by additive manufacturing. For example, stator 10 and rotor 20 may be made at the same time by additive manufacturing.

Stator 10 comprises windings 18 which receive electric power from power source 110 to generate magnetic fields (when machine 100 is operating as a motor). In some embodiments windings 18 are toroidal windings that wind around stator 10 in the poloidal direction.

Rotor 20 carries permanent magnets 24. Magnets 24 may, for example comprise magnets such as iron-neodymium-boron (e.g. Nd₂Fe₁₄B) or samarium-cobalt (e.g. SmCos) or aluminum-nickel-cobalt or ferrite magnets.

The magnetic fields generated by windings 18 interact with the magnetic fields from magnets 24 to drive rotor 20 to rotate in a toroidal direction 102 around axis 115. Shaft 120 is mechanically coupled to rotor 20 by member 121 so that shaft 120 rotates with rotor 20.

In some embodiments, the inner surface of rotor 20 which faces into bore 21 is shaped to conform to the shape of stator 10. For example, the minimum radial distance between an outer surface of stator 10 and an inner surface of rotor 20 may be substantially the same across the poloidal angular range Φ_{R} spanned by rotor 20.

FIG. 1B shows a section of an example rotor and stator having the geometry as shown in FIG. 1A.

In any embodiment a rotor may be constructed to include a non-magnetic holder to which magnets are attached using adhesive, mechanical straps, clamps etc. The rotor holder may, for example be made of aluminum or carbon-fiber. Permanent magnets can also or in the alternative be formed on a holder using additive manufacturing methods, such as cold-spraying to deposit magnetic material to form the magnets. Ferromagnetic materials (e.g. SMCs) may be deposited onto the magnets and/or the holder in bodies shaped to guide magnetic flux in desired ways (e.g. as described in the various embodiments discussed herein).

### 2. Example Stator Constructions

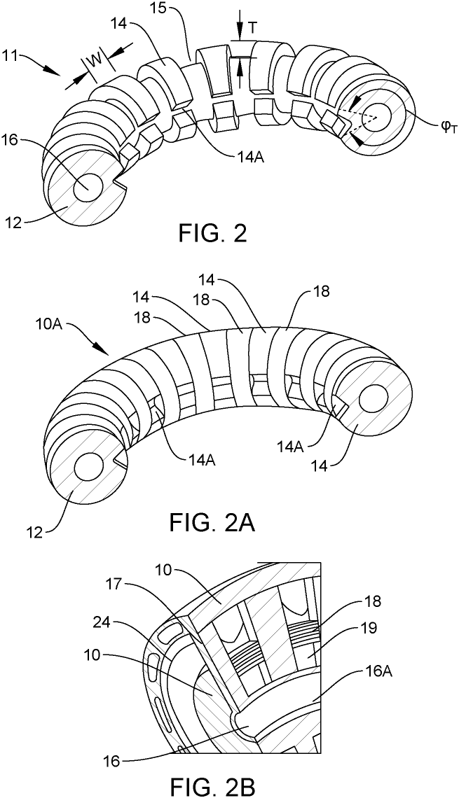

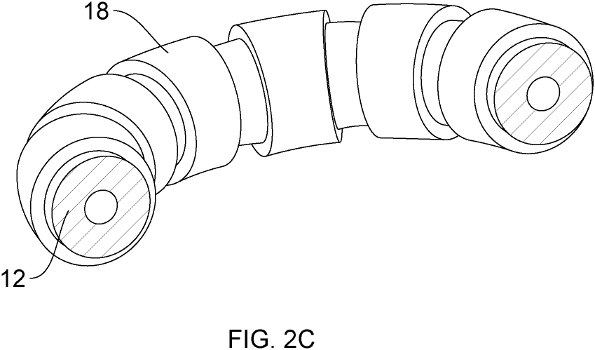

FIG. 2 is a perspective view of a section of an example stator core 11 of stator 10 according to an example embodiment. Stator core 11 comprises a body 12 that is torus shaped or generally torus shaped. Body 12 is made of a magnetically permeable material.

A plurality of grooves or slots 15 extend circumferentially around body 12 and are spaced apart along body 12 in the toroidal direction 102. Grooves 15 are dimensioned to receive coils 18 (see FIG. 2A). Ribs 14 are formed between adjacent ones of grooves 15. Ribs 14 serve as pole pieces for stator 10.

Ribs 14 are preferably cut away in their portions corresponding to slit 23. FIG. 2 shows cut outs or gaps 14A in ribs 14. This configuration helps to concentrate magnetic fields generated by coils 18 in the poloidal angular range φ_{R} spanned by rotor 20. In some embodiments gaps 14A are V-shaped. For example, sides of gaps 14A may follow lines that extend radially in stator core 10.

Gaps 14A may have alternative constructions, for example:
gaps 14A may be provided by a slot or groove extending in toroidal direction 102 around stator 10 and passing through ribs 14;
gaps 14A may be provided by narrowing ribs 14 in their portion adjacent to slit 23.
gaps 14A may be filled with a non-magnetic material or materials.

In cases where ribs 14 comprise gaps 14A, ribs 14 may span a poloidal angular range Φ_{T} in a range of 180°- 355° about the toroidal central axis of stator 10. Preferably the poloidal angular range Φ_{T} spanned by ribs 14 is at least approximately the same as the poloidal angular range Φ_{R} spanned by rotor 20. In some embodiments, the poloidal angular offset between edges of gaps 14A and edges of slit 23 are less than 8°(see e.g. FIG. 1B).

Ribs 14 and slots 15 (and other similar components) can be characterized as having width dimensions W oriented in a direction parallel to toroidal direction 102 and thickness dimensions T oriented in a radial direction (i.e. a direction orthogonal to poloidal direction 101 and passing through the toroidal central axis of stator 10).

Ribs 14 are preferably equally spaced around body 12. In some embodiments ribs 14 are equal in width. In some embodiments slots 15 are equal in width. The relative widths of ribs 14 and slots 15 may be adjusted. For example, slots 15 may be designed to be wider than ribs 14 to provide a larger volume to accommodate windings 18. Providing more volume for windings 18 can increase the output power of motor 100. Alternatively, slots 15 may be designed to be narrower so that ribs 14 can be made wider. Providing wider ribs 14 can help to avoid or reduce the likelihood of magnetic saturation of stator 10.

In some embodiments, stator core 11 is made of suitable soft magnetic composite materials (“SMCs”). Such materials typically comprise particles of ferromagnetic material (e.g. iron powder) which are electrically insulated from one another. A stator core 11 may be formed from a SMC by compacting (e.g. by direct pressing) a powder of ferromagnetic particles coated with an electrically insulating layer into the shape of core 11 or into shapes of components that may be assembled to make core 11. SMCs may also be formed into desired shapes by additive manufacturing processes.

### 3. Example Rotor Constructions

Rotor 20 may be constructed in various ways that facilitate the general architecture described herein. Ideally rotor 20 provides:
a slit 23 that accommodates support(s) for stator 10,
circumferentially spaced apart magnetic poles at which magnetic flux is concentrated,
the magnetic poles alternate in polarity as one travels around rotor 20 in toroidal direction 102, and
the magnetic poles extend around rotor 20 in poloidal direction 101 to provide regions of concentrated magnetic flux that wrap around stator 10 from one edge of slit 23 to an opposing edge of slit 23.

In some embodiments rotor 20 has the form of a toroidal shell with a slit 23 extending around the shell in toroidal direction 102 wherein all or most of the shell is covered by ferromagnetic material. The ferromagnetic material includes magnets and may additionally include SMC, iron or steel or other ferromagnetic material arranged to concentrate magnetic flux from the magnets at poles that face into a bore 21 of the shell.

In some embodiments rotor 20 comprises magnets and SMCs arranged to channel magnetic flux from the magnets.

### 4. Shape Optimization

In some embodiments magnetic material in a component such as a rotor 20 and/or a stator core 11 is shaped so that the magnetic material has a high utilization (i.e. so that when the component is in use, most or all of the magnetic material supports a magnetic flux density that is higher than a threshold flux density). A suitable shape may, for example, be arrived at by creating a computer model of the component that is configured to receive magnets (e.g. coils 18 or magnets 24) of desired dimensions. The model may be processed to estimate magnetic flux density at points within the component when the magnets are present and, if applicable, energized. The model may then be refined by removing material from the component in areas where the estimated magnetic flux density is below a threshold. In some embodiments the threshold is set relative to a maximum magnetic flux density estimated from the model and/or a magnetic flux density at which the material of the component is magnetically saturated. This process may be iterated to refine the shape of the component to yield a component such as a rotor 20 or stator core 11 which is reduced in weight and size but retains desired magnetic properties and performance.

For example, additive manufacturing using SMCs may be used to fabricate a stator core 11 or rotor 20 that has an arbitrarily shaped outer surface as may, for example, be determined by modelling as described above.

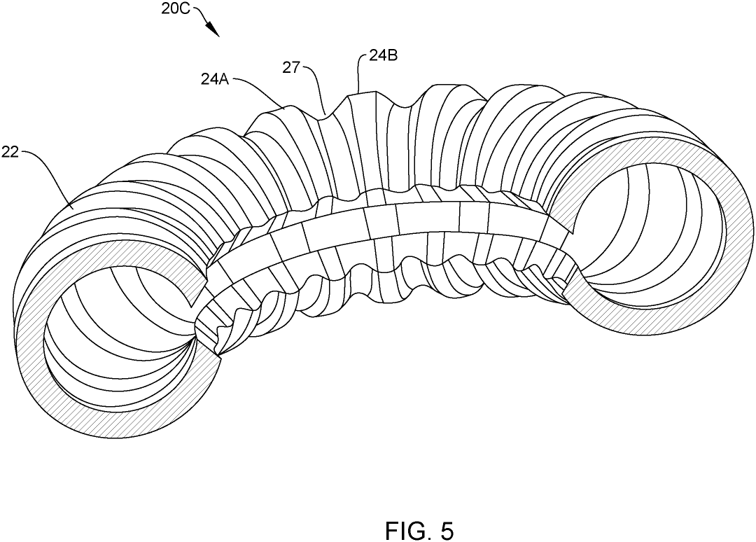

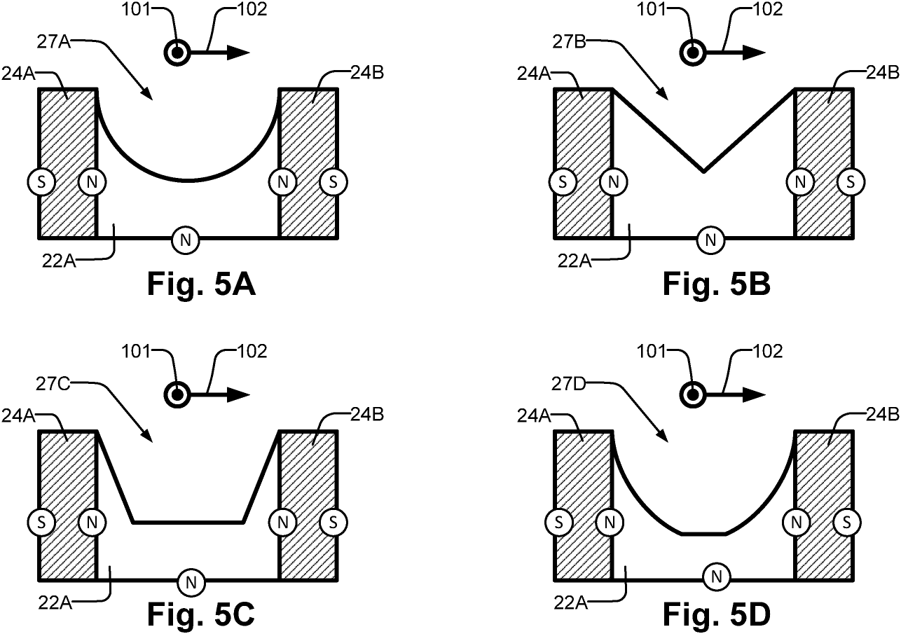

These techniques can be particularly effective at providing a rotor configuration in which performance is preserved but weight is significantly reduced. This is particularly the case where magnets 24 in rotor 20 are oriented tangentially (see e.g. FIG. 5).

In some embodiments, a magnetic flux gradient in the material of a rotor 20 just inside an outer surface of the rotor 20 between magnets 24 is oriented substantially perpendicular to the surface of rotor 20. In some embodiments, outer surfaces of rotor 20 between magnets 24 follow surfaces of uniform or close to uniform (e.g. ±20%) flux density.

In some embodiments, a magnetic flux gradient in the material of a stator core 11 just inside surfaces of ribs 14 is oriented substantially perpendicular to the surface of ribs 14. In some embodiments, surfaces of ribs 14 follow surfaces of uniform or close to uniform (e.g. ±20%) flux density.

### 5. Heat Management

Heat energy is released in stator 10 and/or rotor 20 when a machine as described herein is operating. The heat may be released, for example, as a result of resistive losses in windings 18 (“I²R losses”), hysteresis and eddy current losses in stator core 11, eddy current losses in magnets and dissipation of mechanical vibrations in stator 10. Machines as described herein may include means for cooling stator 10.

Stator core 11 optionally comprises one or more cooling channels 16. Channels 16 may operate to carry heat out of stator 10. A fluid coolant such as air, water, oil, alcohol (e.g. methanol or ethanol) may be provided in channels 16. Cooling channel 16 may carry circulating fluid (which may be supplied to stator 10 and removed from stator 10 by one or more conduits extending through slit 23. The conduit(s) may be on, in or adjacent to support 112 for example. Cooling channels 16 may optionally be configured as a heat pipe to carry heat within and/or out of stator 10.

In the illustrated embodiment, stator core 11 includes a cooling channel 16 that extends in toroidal direction 102 around stator 10. Cooling channel 16 may, for example extend along a centerline of stator 10 (e.g. where stator 10 has a circular cross section when cut in a plane that includes axis 115, the centre of the circular cross section may lie within cooling channel 16 - e.g. at the centre of cooling channel 16). Cooling channel 16 is not necessarily circular in cross section, for example, cooling channel 16 may be formed to have a wall of another shape that provides greater surface area for heat transfer.

By locating cooling channel 16 within stator 10, cooling channel 16 can be placed in good thermal contact with windings 18 without interfering with the linkage of magnetic flux from windings 18 into ribs 14. Cooling channel 16 may be in close physical proximity to windings 18. Heat generated in stator 10 (e.g. by windings 18) may be caused to flow toward the center of stator 10, thereby reducing the temperature of stator 10 and preventing overheating of windings 18 and magnets 24.

In a currently preferred embodiment, cooling channel 16 extends completely around stator core 11 in the toroidal direction. Cool fluid may be circulated into cooling channel 16 and warmed fluid may be withdrawn from cooling channel 16 at any desired locations. In some embodiments, cooling channel is divided into segments and each of the segments has one or more fluid inlets and one or more fluid outlets.

Cooling channel 16 may, for example, make up about 5% to 30% of the volume of body 12 of stator core 11.

Stator core 11 optionally comprises spokes 17 which extend radially away from stator core 11 (see e.g. FIGS. 2B and 7E). Spokes 17 may be made of a material that has a high thermal conductivity and/or may comprise heat pipes. Spokes 17, may, for example, comprise a thermally conductive metal such as aluminum or copper. Spokes 17 may extend radially away from cooling channel 16.

Spokes 17 serve as pathways to conduct heat from the body of stator 20 to cooling channel 16. In some embodiments spokes 17 pass close to ends of coils 18 such that spokes 17 serve as pathways to carry heat from coils 18 to cooling channel 16.

In some embodiments such as the embodiment illustrated in FIG. 2B spokes 17 may extend radially past coils 18 to closely approach the wall of bore 21. In such embodiments spokes 17 may have enhanced effectiveness for carrying heat from rotor 20 to cooling channel 16.

In some embodiments such as the embodiment illustrated in FIG. 2B a wall 16A of cooling channel 16 is made of a thermally conductive material and spokes 17 are in thermal contact with and may optionally be integral with the thermally conductive material of wall 16A.

In some embodiments, cooling channel 16 and spokes 17 serve as a skeleton or framework on which other parts of stator 10 can be supported and/or deposited. In some embodiments the wall 16A of cooling channel 16 and/or spokes 17 enhance mechanical properties (e.g. stiffness) of stator 20.

In addition to removing heat from stator 10, cooling channel 16 may reduce the temperature of stator 10 to a temperature that is lower than that of rotor 20 such that heat can flow from rotor 20 to stator 10 from where the heat can be removed by way of cooling channel 16.

In some embodiments cooling is provided to the outside of rotor 20. Cooling may remove heat from rotor 20 that arises for example from hysteresis and eddy current losses in rotor 20. A cooled surface may be provided outside of rotor 20 (see for example FIG. 7). The cooled surface, may, for example, comprise a shroud that substantially encloses rotor 20. The cooled surface may be cooled by circulating fluid through passages that are in thermal contact with the cooled surface (see for example cooling channels 216 in FIG. 7). The cooled surface may be placed very close to the outer surface of rotor 20 such that the gap between rotor 20 and the cooled surface and rotor 20 has a relatively small thermal resistance,

In some embodiments cooling is provided to both a stator 10 and a cooled surface that is outside of rotor 20. In such embodiments heat may be removed from rotor 20 both by way of stator cooling circuit(s) and by way of the cooled surface.

### 6. Example Stator Winding Constructions

A stator in a machine as described herein may have any of a wide range of winding constructions.

FIG. 2A is a perspective view of a section of a wound stator 10A according to an example embodiment. Stator 10A comprises windings 18 wrapped around stator core 11 in poloidal direction 101. The outer surfaces of windings 18 may be in substantial alignment with outer surfaces of ribs 14 although this is not mandatory (e.g. the outer surfaces of ribs 14 may protrude radially relative to the outer surfaces of windings 18). Outer parts of windings 18 may be made to radially align with outer surfaces of ribs 14 to maximize utilization of corresponding slots 15. Making ribs 14 project radially past the outer surfaces of windings 18 may help reduce magnet eddy current losses and/or winding AC losses.

In some embodiments, stator 10 does not have ribs 14 or slots 15 (i.e. stator 10 may have a slot-less structure). In such embodiments, windings 18 may be wound directly on the outer surface of body 12 of stator core 11 (e.g. see FIG. 2C).

Windings 18 may be connected in integral or fractional configurations. In integral configurations, the ratio between the number of slots 15 (and corresponding windings 18) and the number of magnetic poles of rotor 20 is an integer (e.g. 1, 2, 3, 4, 5, etc.) multiplied by the number of phases of the electrical power used to drive windings 18. For example where a motor is powered by three phase power rotor 20 may have 3, 6, 9 ... etc. times as many poles as there are windings 18 on stator 10. In such embodiments each winding 18 may be connected to one phase of the electrical power with adjacent windings 18 being connected to different phases.

Where windings 18 are connected in a fractional configuration then the ratio between the number of slots 15 (and corresponding windings 18) and the number of magnetic poles of rotor 20 is a fraction (e.g. ¼, ½, 3/7, 3/11, ⅖, 2/7, 4/8, 3/10, 5/14, 5/16, etc.) times the number of phases. In both integral and fractional configurations some or all of windings 18 may comprise multi-layer windings connected to be driven by different phases of the supplied electrical power.

In some embodiments, windings 18 comprise distributed windings. The distributed windings may be covered by separate insulators. Some or all slots 15 may receive two or more distributed windings. Distributed windings typically utilize a larger number of slots/coils compared to fractional windings. Distributed windings can advantageously reduce rotor loss. Distributed windings may create magnetic fields with relatively low content of harmonics. In some embodiments (e.g. for rotor designs with interior magnets), distributed windings can take advantage of the magnetic reluctance variation at different positions of a rotor core to generate an additional reluctance torque component that enhances the motor torque.

In some embodiments, windings 18 are short-pitched, meaning that the width of windings 18 in toroidal direction 102 is smaller than the pitch of the poles of rotor 20 in toroidal direction 102. In some embodiments windings 18 are full pitched, meaning that the width of windings 18 in the toroidal direction is equal to the pitch of the magnetic poles of rotor 20. Short pitched windings 18 advantageously result in a waveform for back electromotive force (“back EMF”) that is more nearly sinusoidal than the back EMF waveform for full pitched windings and therefore contains less high frequency harmonics. This can advantageously lead to reduced torque ripple at loading conditions and/or reduced rotor losses.

The configuration of windings 18 may be selected to optimize operation of a machine as described herein for a particular purpose. For example, different distributed and concentrated winding configurations can impact magnet loss and overall motor performance. Tradeoffs can be made between efficiency and other performance metrics such as average torque and torque ripple. For example, the characteristics of: a fully pitched distributed winding with 60-slot/20-pole and three fractional concentrated windings with 18-slot/20-pole, 24-slot/20-pole and 24-slot/22-pole are provided in Table I.

TABLE I

COMPARISON OF DIFFERENT WINDING CONFIGURATIONS

| | 60-slot / 20-pole | 18-slot / 20-pole | 24-slot / 20-pole | 24-slot / 22-pole |
|---|---|---|---|---|
| Fundamental winding factor | 1.000 | 0.945 | 0.933 | 0.95 |
| Average torque (N.m) | 479.73 | 491.65 | 494.65 | 518.22 |
| Torque ripple (%) | 95.39 | 6.38 | 12.95 | 5.78 |
| Magnet loss (Watt) | 1.979 | 11.105 | 6.417 | 6.498 |
| Total loss (Watt) | 9.063 | 19.158 | 14.576 | 13.802 |

It can be seen that the 60-slot/20-pole distributed winding design has the lowest magnet eddy current loss. However, this configuration also has significant torque ripple that could be undesirable in some applications. Among the configurations listed in Table I, the 24-slot/22-pole configuration shows the highest average torque and the lowest overall loss and torque ripple.

In some embodiments, power source 110 applies a sinusoidal current waveform to windings 18. Applying a sinusoidal current waveform to windings 18 allows machine 100 to operate as a permanent magnet synchronous motor with sinusoidal or nearly sinusoidal back EMF. Permanent magnet synchronous motors have the advantage of smooth operation which may be preferable for applications such as electrified transportation systems.

In some embodiments, power source 110 applies rectangular current waveform to windings 18. In these embodiments, windings 18 and magnets 24 may provide a back EMF with a trapezoidal waveform so that machine 100 operates as a brushless DC motor. Brushless DC motors can achieve a higher power density than permanent magnet synchronous motors but may have higher toque ripple.

### 7. Example Rotor Constructions

### 7.1 Rotor Example 1 - Radially Magnetized Magnets

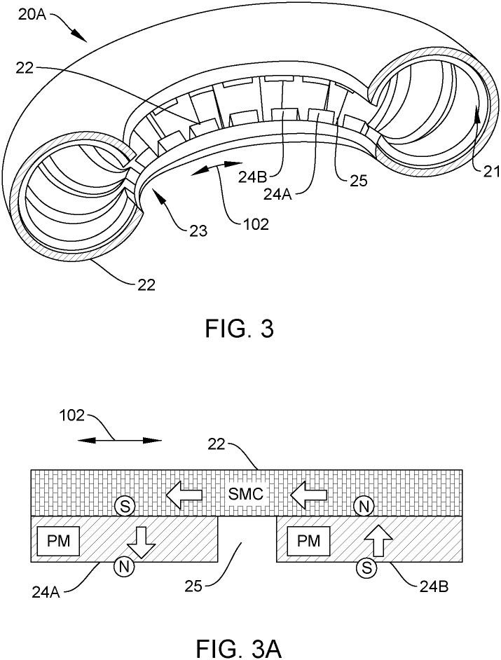

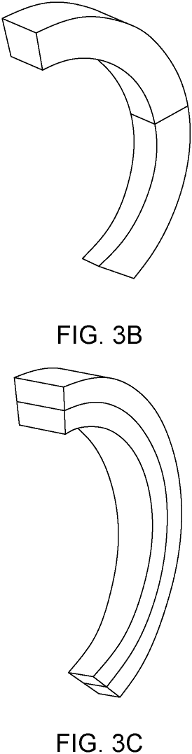

FIG. 3 is a perspective view of a section of a rotor 20A according to one example embodiment. Rotor 20A is preferably shaped like a circular torus and/or elliptic torus to conform to the shape of stator core 11 although other shapes are possible (e.g. other toroids).

Rotor 20A comprises a shell 22 housing a plurality of magnets 24 spaced apart in toroidal direction 102 around an inner surface of shell 22.

Shell 22 is curved to define bore 21 that extends in toroidal direction 102. Bore 21 is dimensioned to accommodate stator 10.

Shell 22 comprises slit 23 that extends around rotor 20A in toroidal direction 102. As depicted in FIG. 1, opening 23 allows one or more supports 112 for a stator (e.g. casing 200 in FIG. 7) to pass into bore 21 and hold stator 10 in place.

Slit 23 is oriented inwards and facing towards axis of rotation 115 in the FIG. 3 example embodiment although this is not necessary. Slit 23 may be oriented towards any suitable direction (e.g. outward, upward, downward, etc.) based on the design and/or orientation of stator supports 112.

Magnets 24 are attached to the inner surface of shell 22. Each magnet 24 has the form of a ring with a section cut out that corresponds to slit 23. Magnets 24 are arranged to provide magnetic poles that alternate in polarity as one travels around rotor 24 in the toroidal direction.

In rotor 20A, magnets 24 are magnetized in a radial direction. Magnets 24 include magnets 24A that have a North magnetic pole on their radially inward faces and a South magnetic pole on their radially outward faces and magnets 24B in which the South magnetic pole faces radially inward and the North magnetic pole faces radially outward. Magnets 24A and 24B alternate as one travels around rotor 20A in toroidal direction 102. Each magnet 24 provides a pole of rotor 20. Adjacent magnets 24 are spaced apart by a pole pitch. Adjacent magnets 24 are separated by spaces 25.

Magnets 24 are backed by a ferromagnetic material 22A. For example, shell 22 may comprise or be made of suitable ferromagnetic material 22A such as a soft magnetic composite (“SMC”) material.

FIG. 3A shows how a ferromagnetic backing material in shell 22 can direct magnetic flux of magnets 24A and 24B in toroidal direction 102 to create an airgap flux that passes through stator coils 18.

In some embodiments, shell 22 and/or magnets 24 are fabricated using additive manufacturing techniques such as cold spraying, binder jetting, etc.

In some embodiments, magnets 24 are segmented. Segmenting magnets 24 can advantageously help reduce the magnet eddy current loss. FIG. 3B illustrates an example in which a magnet is divided into segments in poloidal direction 101. FIG. 3C illustrates an example in which a magnet 24 is segmented in a radial direction.

### 7.2 Rotor Example 2 - Tangentially Magnetized Magnets

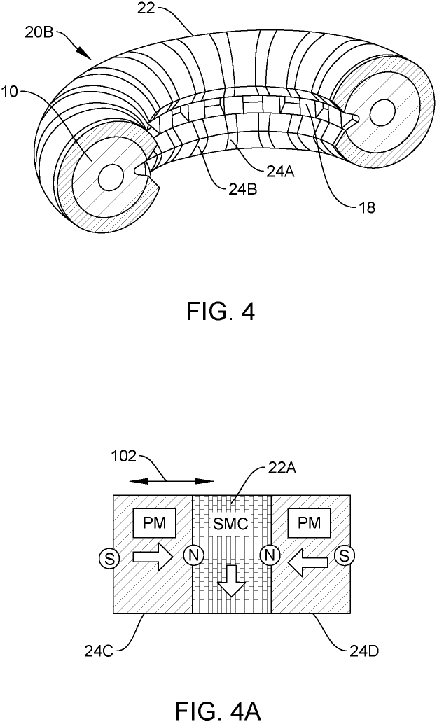

FIG. 4 is a perspective view of a section of a rotor 20B wrapped around stator 10 according to another example embodiment. Like rotor 20A, rotor 20B is shaped like a circular torus and/or elliptic torus to conform to the shape of stator core 11 although other shapes are possible (e.g. other toroids). Rotor 20B comprises a bore 21 which accommodates stator 10.

Rotor 20B comprises a plurality of magnets 24 which form a part of shell 22. Magnets 24C and 24D are shown. Magnets 24C, 24D are spaced apart around shell 22 in toroidal direction 102. Each of magnets 24C, 24D has the form of a ring with a section corresponding to slit 23 missing. In rotor 20B magnets 24C, 24D are oriented tangentially (i.e. magnets 24C, 24D are magnetized so that north and south poles are respectively on opposed faces of magnets 24 that face along an axis that extends around bore 21 in toroidal direction 102).

In the illustrated embodiment, magnets 24C and 24D alternate as one travels around rotor 20B in toroidal direction 102. The north pole of each magnet 24C faces the north pole of the adjacent magnet 24D on a first side. The south pole of each magnet 24C faces the south pole of the adjacent magnet 24D on a second side opposed to the first side. Magnets 24C and 24D may optionally have identical constructions (except for the direction in which their poles are oriented relative to rotor 20B).

As illustrated in FIG. 4A the spaces between adjacent magnets 24C, 24D contain a ferromagnetic material 22A that channels magnetic flux from the magnets 24C, 24D to poles of rotor 20B.

Rotor 20B may provide advantages including one or more of the following:
The arrangement of magnets 24 and shell 22 in rotor 20B forces magnetic flux to enter the air gap between rotor 20B and stator 10 through material of shell 22 (e.g. soft magnetic composites). This reduces the exposure of magnets 24 to damaging armature field harmonics. This can advantageously reduce magnet eddy current losses and/or improve the overall efficiency of motor 100 as described elsewhere herein.
The arrangement of magnets 24 and shell 22 in rotor 20B can generate an additional reluctance torque component based on attraction between the armature field and the material of shell 22. The additional reluctance torque component can advantageously enhance the overall output torque of motor 100.
The proximity of the ferromagnetic material of shell 22 to stator 10 increases the inductance of windings 18. Increasing the inductance of windings18 can advantageously improve fault tolerance of motor 100, limit short circuit current, facilitate control of motor 100 at high speeds (due to the improved field weakening capability), etc.
Fabrication costs can be reduced and fabrication processes can be simplified due to the relatively simple geometry of magnets 24 (e.g. ring geometry).
The magnetization process of magnets 24 is simple (i.e. magnetizing magnets 24 in a direction perpendicular to the side surface of magnets 24) and attainable using standard magnetization fixtures.
Weight may be reduced since rotor 20B does not require a shell of ferromagnetic backing material.

### 7.3 Rotor Example 3 - Tangentially Magnetized Magnets

FIG. 5 is a perspective view of a section of a rotor 20C according to a further example embodiment. Rotor 20C is constructed like rotor 20B except that ferromagnetic material 22A in spaces between adjacent magnets 24 is concentrated toward the inside of shell 22 (i.e. as compared to rotor 20B, material 22A is cut away on an outside of shell 22 in cutout regions 27). With this construction, the size of the air gap at the center of shell 22 is smaller than that at the sides of magnets 24. This can lead to a more sinusoidal spatial distribution of the air gap flux, reduce the air gap harmonics and/or reduce motor torque ripple.

FIGS. 5A to 5D illustrate ferromagnetic material 22A in a space between two magnets 24 but neglect curvature of rotor 20C. As illustrated in FIGS. 5A to 5D, ferromagnetic material 22A covers the surface of poles of magnets 24 (in this particular example, North poles). Cutouts 27 extend part way through shall 22 between magnets 24. As a result, the thickness of ferromagnetic material 22A adjacent to cutout regions 27 may be smaller than the thickness of magnets 24. In some embodiments, the ratio of the minimum thickness of shell 22 at cutout regions 27 to the thickness of magnets 24 is in the range of about 0.3 to 0.7.

Shaping ferromagnetic material 22A to include cutout regions 27 can advantageously reduce the weight of rotor 22C and also can help to concentrate magnetic flux from magnets 24 in an air gap between rotor 22C and a stator received in bore 21 of rotor 22C.

The shapes and/or sizes of cutout regions 27 may be varied. FIGS. 5A to 5D show non-limiting example surface profiles for cutout regions 27. Profiles for ferromagnetic material 22A in cutout regions 27 may be generated by modelling the magnetic field produced with various surface profiles for ferromagnetic material 22A and optimizing the surface profiles to find a good balance between reduced rotor weight and desired magnetic fields in the gap between rotor 20C and a stator 10. Reducing the weight of rotor 20C and/or improving the magnetic material utilization of rotor 20C can advantageously allow motor 100 to output a higher torque and/or increase motor torque density and/or provide faster acceleration of a rotor 20.

In some embodiments ferromagnetic material 22A, which may, for example, be provided by a SMC is shaped on the inside (i.e. on its side which forms part of the wall of toroidal bore 21) to have a curved shape which bulges toward stator 10 so that an air gap between rotor 20 and stator 10 is shorter in length at the center of pieces of ferromagnetic material 22A than it is between rotor 20 and the sides of magnets 24. This can lead to a more sinusoidal spatial distribution of magnetic flux in the air gap that can reduce air gap harmonics and torque ripple.

### 7.4 Rotor Example 4 - Magnets Arranged as Halbach Array

In a Halbach array, a plurality of magnets is arranged with the direction of magnetization of different ones of the magnets oriented so that a strong magnetic field is produced on a first side of the array while magnetic fields from different ones of the magnets cancel out on a second side of the array that is opposed to the first side of the array. The principle of Halbach arrays may be applied to provide a rotor 20 for an electric machine as described herein in which a strong magnetic field is provided inside bore 21 and very little magnetic field is present outside bore 21.

In a Halbach array, adjacent magnets have different directions of magnetization such that the direction of magnetization rotates as one moves along the array from one magnet to the next. For example, the magnetic field direction of adjacent magnets may be rotated by 90 degrees.

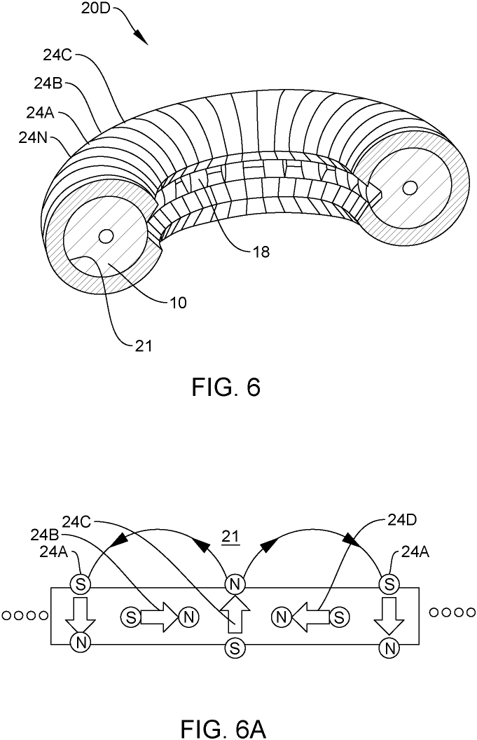

FIG. 6A schematically shows magnetization directions of consecutive magnets 24A, 24B, 24C, 24D in a Halbach array that may be provided in a rotor 20D. Curvature of rotor 20D is neglected in FIG. 6A. In the FIG. 6A example embodiment, the angle θ_{H} between the magnetization directions of adjacent ones of magnets 24A, 24B, 24C, 24D is 90°. In the FIG. 6A example embodiment, magnets 24A are magnetized in a first direction which is radially inward relative to bore 21, magnets 24B are magnetized in a second direction which faces a first way along toroidal direction 102, magnets 24B are magnetized in a third direction which is radially outward relative to bore 21, and magnets 24D are magnetized in a forth direction which faces a second way opposed to the first way along toroidal direction 102.

A rotor 20D may have 4N magnets with each group of four magnets arranged as in FIG. 6A to produce a magnetic field inside bore 21 but almost no magnetic field on the outside of the rotor.

Halbach arrays may be based on groups of more than four magnets. In an n-magnet Halbach array, the angle θ_{H} between the magnetization directions of adjacent magnets 24 may be 360/n. Typical angles θ_{H} between the magnetization directions of consecutive magnets in an Halbach array include, but are not limited to, 10°, 15°, 30°, 45°, 60°, 90°, and 120°.

FIG. 6 shows an example Halbach array rotor 20D comprising a plurality of permanent magnets 24-1, 24-2, ...., 24-N. The directions of magnetization of magnets 24-1, 24-1, ...., 24-N are arranged in a spatially rotating pattern to form one or more Halbach arrays which extend in toroidal direction 102.

In rotor 20D, magnets 24-1, 24-2, ..., 24-N are tapered in width (e.g. wedge shaped) such that there are no significant gaps between adjacent ones of magnets 24-1, 24-2, ...., 24-N. Magnets 24-1, 24-2, ..., 24-N can be optionally attached (e.g. using adhesives, by additive manufacturing methods such as cold-spray, etc.) to a non-magnetic rotor holder. The rotor holder may, for example, be fabricated from materials such as aluminum, carbon fiber composites, etc.

Halbach array rotor 20D advantageously does not need a ferromagnetic back core (e.g. as provided by shell 22 in example rotor 20A). Arranging magnets in a toroidal rotor geometry in a Halbach array as in rotor 20D for example can advantageously provide increased no-load magnetic flux density in the gap between the inside of rotor 20D and stator 10. This can lead to a higher output torque (for the same electric conditions) and/or a higher torque density (torque per unit weight of rotor and stator) due to the exclusion of a rotor back core.

### 7.5 Shifting Rotor Magnets

In some embodiments, magnets on the rotor are displaced away from the stator toward the outer surface of the rotor by a small distance (e.g. 1 mm or so). such displacement can increase overall efficiency of a machine as described herein by reducing exposure of the magnets to armature field harmonics. 3D finite element analysis simulations comparing two motors as described herein where rotor magnets in one of the motors are shifted outwardly relative to the magnet position in the other motor show that the motor with the shifted magnets design had slightly higher copper loss, as the average torque is reduced by 0.6%. On the other hand, the motor with the shifted magnets had a magnet eddy-current loss that was reduced by 32% in comparison to the other motor.

### 8. Example Machine Construction

FIG. 7 is a perspective view of a section of an electric machine 1000 (which may function as a motor and/or a generator) according to an example embodiment. Machine 1000 comprises a permanent magnet motor 100 contained within a casing 200. Rotor 20 of machine 100 is connected shaft 120 by a rotor holder 121. Shaft 120 extends axially and is supported by bearings 210.

In some embodiments, rotor holder 121 is made of one or more suitable non-magnetic materials such as suitable grades of plastic, non-magnetic metal such as aluminum, titanium, non-magnetic stainless steel, or the like.

In the illustrated embodiment, casing 200 forms a toroidal chamber 201 that extends around the outside of rotor 20. Chamber 201 may fit closely to rotor 20 leaving sufficient clearance so that casing 200 does not interfere with free rotation of rotor 20.

In the illustrated embodiment casing 200 extends radially inwardly toward shaft 120 and supports bearings 210.

Casing 200 may be made of separable parts to facilitate assembly of machine 1000 (e.g. casing 200 may be made in two halves that can be split apart to allow motor 100 to be inserted into casing 200).

In machine 1000, stator 10 is supported by casing 200 by way of a support 112A that extends from an interior surface of casing 200 through slit 23 of rotor 20 to hold stator 10 in place. Support 112A may comprise any of a wide variety of support structures including, for example, one or more of:
a plurality of spaced apart posts or spokes,
a flange,
a plurality of tensioned cables,
etc.
to attach to stator 10 Opening 23 is oriented outwards (i.e. opening 23 opens away from axis of rotation 103) in the FIG. 7 example embodiment although this is not necessary.

Support 112A may be made of a thermally conductive material that is in good thermal contact with stator 10 and with casing 200 so that support 112A helps to transfer heat away from stator 10.

Casing 200 optionally comprises one or more cooling channels 216. Channel(s) 216 may be located adjacent to rotor 20 and connected to carry a suitable cooling fluid (e.g. as described elsewhere herein).

Cooling channels 216 can receive heat from rotor 20 across the small gap between rotor 20 and casing 200. The gap may for example be filled with air. When rotor 20 is turning the thermal conductivity of the air gap between rotor 20 and casing 200 advantageously increases as the rotational speed of rotor 20 increases. Reducing the temperature of magnets 24 can advantageously make magnets 24 less susceptible to demagnetization from overheating.

### 9. Experimental Results

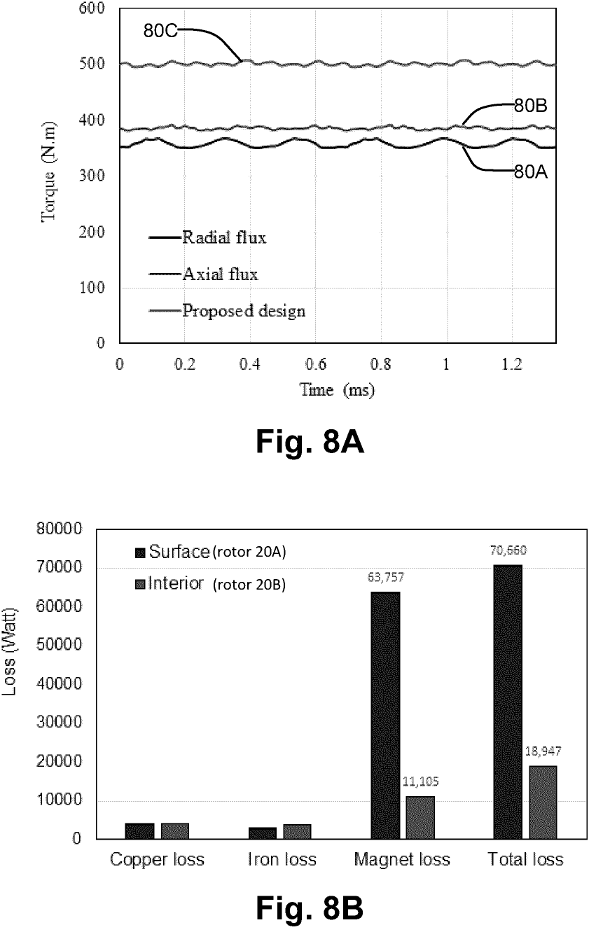

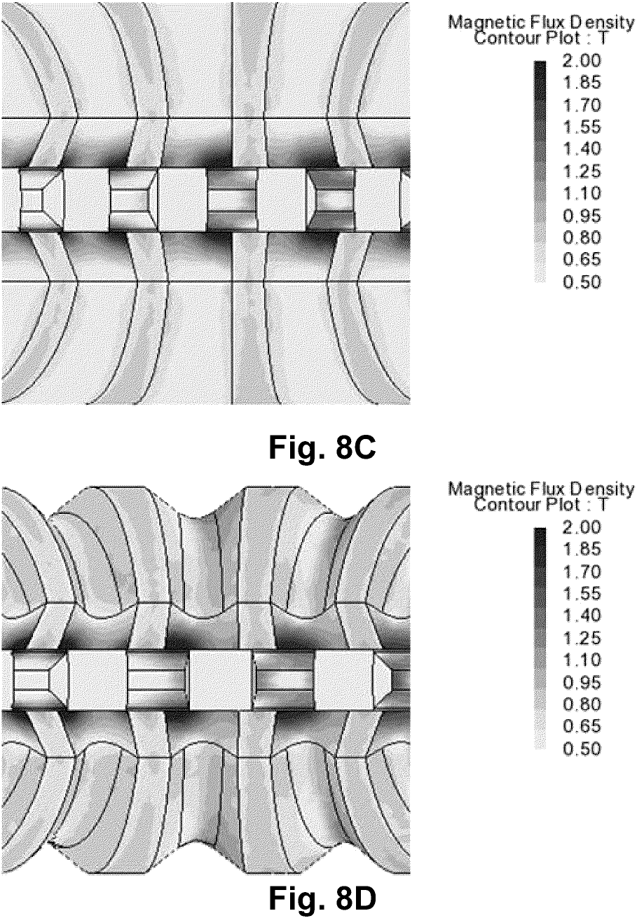

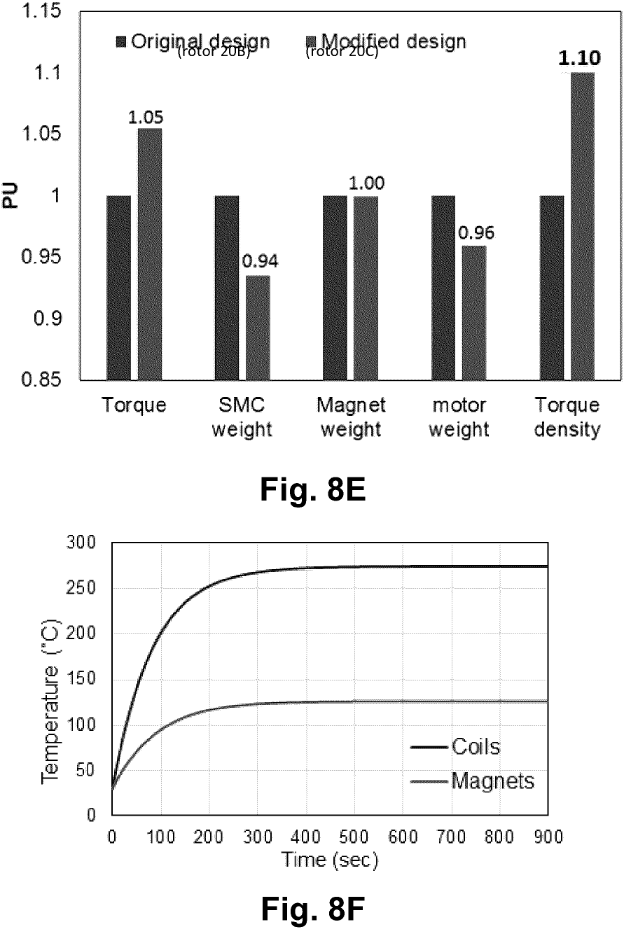

FIGS. 8A-F depict results of case studies using 3D Finite Element Analysis (“FEA”) to compare the performance of various embodiments of motor 100 with conventional permanent magnet motors.

FIG. 8A is a graph comparing the output torque between a conventional radial flux permanent magnet motor (curve 80A), a conventional axial flux permanent magnet motor (curve 80B), and a motor 100 comprising a radially magnetized rotor 20A according to an example embodiment of the invention (curve 80C). The three motors are designed with the same volume, magnet weight, armature electric loading, air gap length and number of stator slots and rotor poles. The simulated output torque of the three motors is shown in FIG. 8A. It can be seen that motor 100 can achieve a higher output torque compared to radial and axial flux motors, with a room for further improvements through design and materials optimization.

For example, 3D FEA simulations show that a tangentially magnetized rotor structure 20B can reduce the magnet eddy current losses by 82.5% compared to the rotor structure 20A leading to a significant improvement in the motor efficiency, as illustrated in FIG. 8B.

FIG. 8C shows the flux density distribution of a tangentially magnetized rotor structure 20B. It can be seen that parts of the SMC between magnets (dark areas) are not efficiently utilized in the magnetic circuit.

As described elsewhere herein the underutilized parts of the SMC may be removed to provide cut out areas 27 (see e.g. FIG. 5). FIG. 8D illustrates magnetic flux density in a rotor 20C as shown in FIG. 5. It can be seen in FIG. 8D that the magnetic material utilization is improved compared to FIG. 8C. This improvement provided 5% higher output torque and 10% improvement in the motor torque density, as shown in the FEA simulation results in FIG. 8E.

FIG. 8F is a graph of FEA simulated maximum temperature of motor 100 at 8182 rpm - 450 kW as a function of time.

### 10. Example Variations

The technology disclosed herein may be varied while retaining certain inventive concepts as described herein. For example:
a rotor having a toroidal physical configuration as described herein may be made with electromagnets in place of the described permanent magnets;
a stator need not be a continuous ring-shaped part. In alternative embodiments a stator may comprise plural arc-shaped segments that are individually supported in a bore of a rotor as described herein.
the roles of rotor 20 and stator 10 may be reversed (i.e. a stator having a toroidal bore may wrap around a rotor located inside the toroidal bore.

Where a component (e.g. a bearing, a shaft, a support, a winding, an assembly, a power source, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of electric machines and related methods have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

It is intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. An electric machine comprising:
a rotor mounted to rotate about an axis, the rotor comprising a shell shaped to provide a toroidal bore centered on the axis and having a slit extending circumferentially around the rotor, the slit penetrating through the shell into the bore, the rotor comprising a plurality of magnetic poles spaced circumferentially around the rotor in the bore; and
a stator supported in the bore by one or more supports extending through the slit of the rotor, the stator carrying a plurality of windings spaced apart around the bore.

2. The electric machine according to claim 1 wherein the magnetic poles each extend in a poloidal direction around an interior surface of the bore from a location near a first edge of the slit to a location near a second edge of the slit.

3. The electric machine according to claim 1 wherein the rotor comprises a plurality of circumferentially spaced-apart permanent magnets and adjacent ones of the magnets are separated by a section of a ferromagnetic material that provides one of the poles.

4. The electric machine according to claim 3 wherein the permanent magnets are magnetized in a direction that is tangential to a diameter of the rotor and wherein circumferentially adjacent ones of the magnets are polarized in opposing directions.

5. The electric machine of claim 3 wherein the magnets comprise ring magnets that extend around the rotor in the poloidal direction and have gaps aligned with the slit.

6. The electric machine according to claim 3 wherein the ferromagnetic material comprises a soft magnetic composite (SMC).

7. The electric machine according to claim 3 wherein an outer surface of the ferromagnetic material is shaped to follow a contour of substantially constant magnetic flux density.

8. The electric machine according to claim 3 wherein normals to the an outer surface of the ferromagnetic material are generally parallel to a gradient of flux density in the ferromagnetic material adjacent to the outer surface of the ferromagnetic material.

9. The electric machine according to claim 3 wherein a surface of the ferromagnetic material on an outside of the rotor is formed with a cut out or groove that extends in the poloidal direction.

10. The electric machine according to claim 1 wherein the rotor comprises a plurality of permanent magnets arranged to form one or more Halbach arrays oriented to concentrate magnetic field within the bore of the rotor.

11. The electric machine according to claim 10 wherein the permanent magnets comprise ring magnets that have gaps aligned with the slit.

12. The electric machine according to claim 6 wherein the rotor comprises a plurality of circumferentially spaced apart permanent magnets magnetized in a direction that is radial to the bore of the rotor.

13. The electric machine according to claim 12 wherein polarities of circumferentially adjacent ones of the magnets alternate.

14. The electric machine according to claim 12 wherein the magnets comprise ring magnets that are radially magnetized and have gaps aligned with the slit.

15. The electric machine according to claim 10 wherein the shell comprises a continuous layer of a ferromagnetic material backing the magnets on a side of the magnets away from the bore of the rotor.

16. The electric machine according to claim 1 wherein a width of the slit is not more than one third of a circumference in the poloidal direction of an inner surface of the rotor.

17. The electric machine according to claim 1 wherein the slit spans an angle relative to a centroid of a cross-sectional of the bore in a plane that includes the axis that is not more than 60 degrees.

18. The electric machine according to claim 1 wherein a ratio of an area of the slit to an area of a toroidal surface on which an inner surface of the rotor lies is not more than 1:12.

19. The electric machine according to claim 1 wherein the stator comprises one or more cooling channels and the electric machine comprises one or more conduits that extend through the slit and are connected to supply cooling fluid to the one or more cooling channels and/or to remove the cooling fluid from the one or more cooling channels.

20. The electric machine according to claim 19 wherein the one or more cooling channels extend toroidally around the stator.

21. The electric machine according to claim 20 wherein the one or more cooling channels extend around the stator on a centerline of the stator.

22. The electric machine according to claim 1 wherein the stator comprises a core of a ferromagnetic material and the windings comprise toroidal windings wound around the core at locations spaced apart along the core.

23. The electric machine according to claim 22 wherein the toroidal windings comprise integral or fractional windings.

24. The electric machine according to claim 22 wherein the core comprises ribs of the ferromagnetic material located between adjacent ones of the windings, the ribs extending around the core in the poloidal direction.

25. The electric machine according to claim 24 wherein the ribs are interrupted at the location where the ribs cross the slit.

26. The electric machine according to claim 25 wherein the ribs are interrupted by V-shaped cutouts that are aligned with the slit.

27. The electric machine according to claim 24 wherein outer surfaces of the toroidal windings and outer surfaces of the ribs are aligned with one another.

28. The electric machine according to claim 24 wherein outer surfaces of the toroidal windings are recessed toward the core relative to outer surfaces of the ribs.

29. The electric machine according to claim 1 comprising a casing shaped to conform with an outer surface of the rotor and positioned to provide a clearance gap between the casing and the rotor.

30. The electric machine according to claim 29 comprising cooling channels in the casing, the cooling channels located adjacent to the rotor and connectible to carry cooling fluid.

31. The electric machine according to claim 1 wherein the one or more supports comprise electrical conductors connected to carry electrical power to or from the stator.

32. The electric machine according to claim 1 wherein the stator comprises spokes located between the windings and extending radially away from the stator.

33. The electric machine according to claim 1 wherein a cross section of the bore in a plane that includes the axis is circular or elliptical.

34. (canceled)

35. The electric machine according to claim 1 wherein the slit is: on a side of the rotor facing away from the axis; on a side of the rotor facing toward the axis; or on a side of the rotor facing parallel to the axis.

36-39. (canceled)
